(19) United States
(12) Patent Application Publication
(10) Pub. No.: US 2026/0280174 A1
(43) Pub. Date: Sep. 17, 2026

(54) SEMICONDUCTOR STORAGE DEVICE

(71) Applicant: Kioxia Corporation, Tokyo (JP)

(72) Inventor: Masayuki DOHI, Yokohama (JP)

(21) Appl. No.: 19/320,592

(22) Filed: Sep. 5, 2025

(30) Foreign Application Priority Data
Mar. 17, 2025 (JP) 2025-042474

(51) Int. Cl. H01R 13/24; G06K 19/077

(52) U.S. Cl. CPC H01R 13/2442; G06K 19/07732

(57) ABSTRACT

A semiconductor storage device includes a case, a movable body, a position support member, and a plate spring. The movable body is movable between a first position at which the connector is accommodated inside the case and a second position at which the connector protrudes outward from an opening of the case. The position support member engages with the case or the movable body and holds the movable body at the second position when the movable body is pushed and moved from the first position in a direction from the first position to the second position, and releases engagement when the movable body held at the second position is pushed from the second position in the direction. The plate spring moves the movable body toward the first position when the engagement of the position support member with the case or the movable body is released.

### CROSS-REFERENCE TO RELATED APPLICATION

This application is based upon and claims the benefit of priority from Japanese Patent Application No. 2025-042474, filed Mar. 17, 2025, the entire contents of which are incorporated herein by reference.

### FIELD

Embodiments described herein relate generally to a semiconductor storage device.

### BACKGROUND

Semiconductor storage devices each including a substrate on which a semiconductor memory is mounted and a connector formed at one end of the substrate are known.

### DESCRIPTION OF THE DRAWINGS

FIG. 1 is a perspective view illustrating an entire semiconductor storage device according to an embodiment;

FIG. 2 is a partially exploded perspective view illustrating the semiconductor storage device according to the embodiment;

FIG. 3 is a diagram illustrating a main case according to the embodiment;

FIG. 4 is an exploded perspective view illustrating the main case according to the embodiment;

FIG. 5 is a partially exploded perspective view illustrating a movable body according to the embodiment;

FIG. 6 is a sectional view illustrating the movable body according to the embodiment located at a first position;

FIG. 7 is a sectional view illustrating the movable body according to the embodiment located at a second position;

FIGS. 8A to 8C are sectional views illustrating movement of a position support member according to the embodiment;

FIG. 9 is a perspective view illustrating a plate spring according to the embodiment;

FIG. 10 is a partially exploded perspective view illustrating a semiconductor storage device according to a fourth modification of the embodiment;

FIG. 11 is a perspective view illustrating an aspect of a plate spring according to a fifth modification of the embodiment; and

FIG. 12 is a perspective view illustrating another aspect of the plate spring according to the fifth modification of the embodiment.

### DETAILED DESCRIPTION

Embodiments provide a semiconductor storage device designed to improve quality.

In general, according to one embodiment, a semiconductor storage device includes a first case, a movable body, a position support member, and a plate spring. The first case includes an opening. The movable body includes a substrate on which a semiconductor memory is mounted, a connector provided at one end of the substrate, and a second case accommodating at least a part of the substrate. The movable body is movable between at least a first position at which the connector is accommodated inside the first case and a second position at which the connector protrudes outward from the opening. The position support member is provided between the first case and the movable body, and engages with the first case or the movable body at the second position and holds the movable body at the second position when the movable body is pushed and moved in a first direction oriented from the first position to the second position. The position support member releases engagement with the first case or the movable body when the movable body held at the second position is pushed once more in the first direction. The plate spring is provided between the first case and the movable body, biases the movable body toward the first position when at least the movable body is held at the second position, and moves the movable body toward the first position when the engagement of the position support member with the first case or the movable body is released.

Hereinafter, a semiconductor storage device according to an embodiment will be described with reference to the drawings. In the following description, identical or similar configurations with the same functions are denoted by the same reference numerals. Repeated description of such configurations may be omitted.

In the present specification, the terms “parallel”, “orthogonal”, or “same” may each include “substantially parallel”, “substantially orthogonal”, or “substantially the same”. The term “overlap” refers to a case in which virtual projected images of two objects overlap. That is, “overlap” is not limited to a case in which two objects are in contact, and include a case in which two objects are not in contact (for example, a case in which there is a space or another member between the two objects). In the present specification, the term “connection” is not limited to mechanical connection and may also include electrical connection.

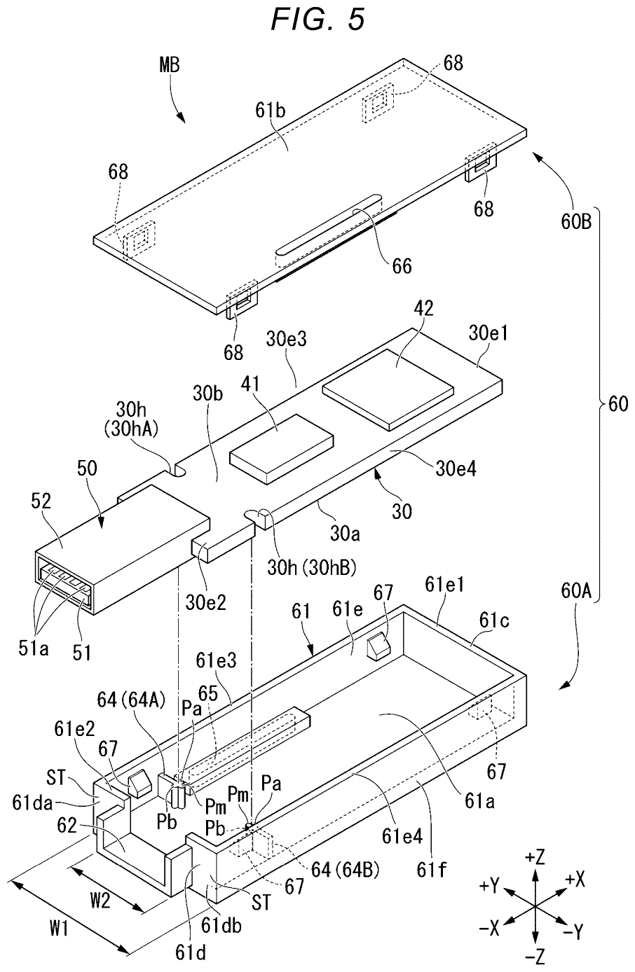

In the present specification, +X, −X, +Y, −Y, +Z, and −Z directions are defined as follows. The +X, −X, +Y, and −Y directions are directions parallel to a second surface 30b of a substrate 30 to be described below (see FIG. 5). The +X direction is a direction oriented from a second end 30e2 to a first end 30e1 of the substrate 30 to be described below (see FIG. 5). The −X direction is a direction opposite to the +X direction. When the +X and −X directions are not distinguished from each other, the +X and −X directions are simply referred to as the “X direction”. The +Y and −Y directions are directions intersecting (for example, orthogonal to) the X direction. The +Y direction is a direction oriented from a fourth end 30e4 to a third end 30e3 of the substrate 30 to be described below (see FIG. 5). The −Y direction is a direction opposite to the +Y direction. When the +Y and −Y directions are not distinguished from each other, the +Y and −Y directions are simply referred to as the “Y direction”. The +Z and −Z directions are directions intersecting (for example, orthogonal to) the X direction and the Y direction and each are a thickness direction of the substrate 30. The +Z direction is a direction oriented from the substrate 30 to a second wall 61b of a movable body case 60 to be described below (see FIG. 5). The −Z direction is a direction opposite to the +Z direction. When the +Z and −Z directions are not distinguished from each other, the +Z and −Z directions are simply referred to as the “Z direction”. The −X direction is an example of a “first direction”. The Y direction is an example of a “second direction”.

### Embodiment

Hereinafter, a semiconductor storage device 1 according to an embodiment will be described.

### 1. Overall Configuration

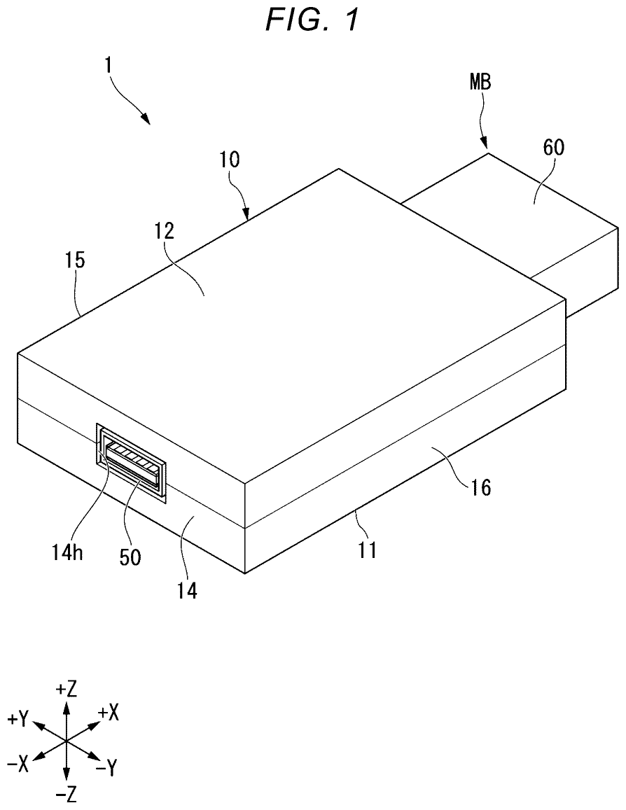

FIG. 1 is a perspective view illustrating an entire semiconductor storage device 1. The semiconductor storage device 1 is, for example, a storage device including a universal serial bus (USB) type connector (so-called USB memory). The semiconductor storage device 1 is, for example, a slide knock type USB memory in which the connector is extendable and retractable by knocking a movable body that is a part of the semiconductor storage device 1 in a specific direction.

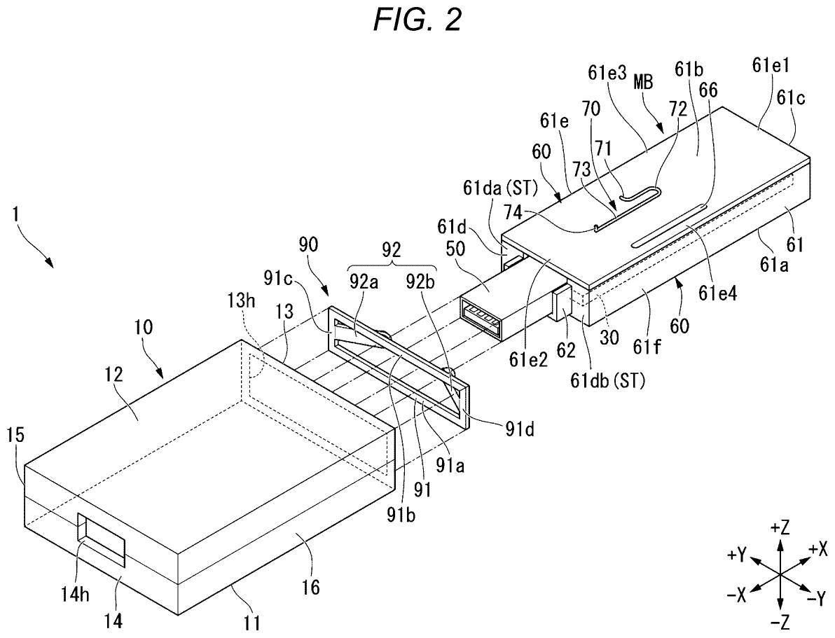

FIG. 2 is a partially exploded perspective view illustrating the semiconductor storage device 1. The semiconductor storage device 1 includes, for example, a main case 10, a movable body MB, a position support member 70, and a plate spring 90.

### 2. Main Case

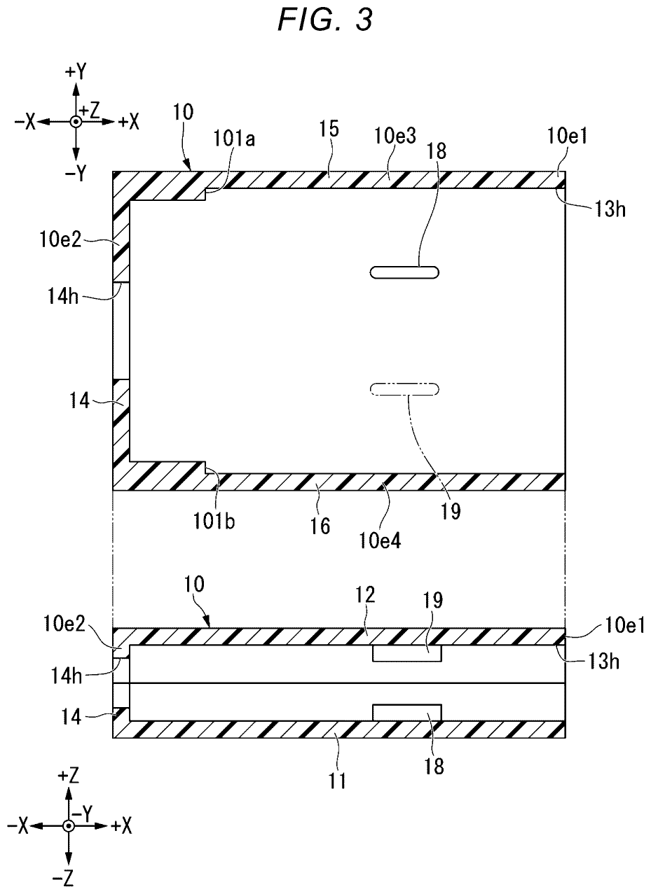

First, the main case 10 will be described. FIG. 3 is a diagram illustrating the main case 10. The main case 10 has a flat box shape extending along the X direction and the Y direction. The main case 10 is an example of a “first case”.

The main case 10 includes a first end 10e1, a second end 10e2, a third end 10e3, and a fourth end 10e4. The first end 10e1 is an end in the +X direction. The second end 10e2 is located on a side opposite to the first end 10e1. The second end 10e2 is an end in the −X direction. The third end 10e3 is an end in the +Y direction. The fourth end 10e4 is located on a side opposite to the third end 10e3. The fourth end 10e4 is an end in the −Y direction.

The main case 10 includes a first main wall 11, a second main wall 12, an end wall 14, a first side wall 15, and a second side wall 16. Each of the first main wall 11 and the second main wall 12 is a wall extending along the X direction and the Y direction. Each of the first main wall 11 and the second main wall 12 is larger than the end wall 14, the first side wall 15, and the second side wall 16 to be described below. The first main wall 11 is oriented in the −Z direction. The second main wall 12 is located on a side opposite to the first main wall 11 and oriented in the +Z direction.

The end wall 14 is a wall extending along the Y direction and the Z direction. The end wall 14 is located at the second end 10e2 of the main case 10 and oriented in the −X direction. Each of the first side wall 15 and the second side wall 16 is a wall extending along the X direction and the Z direction. The first side wall 15 is located at the third end 10e3 of the main case 10 and oriented in the +Y direction. The second side wall 16 is located at the fourth end 10e4 of the main case 10 and oriented in the −Y direction.

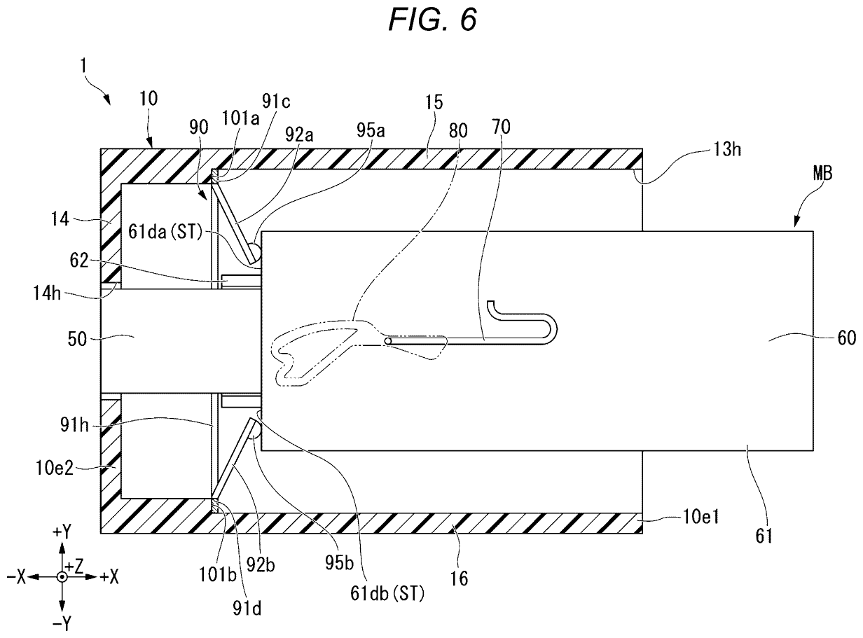

A first opening 13h is provided at the first end 10e1 of the main case 10. The first opening 13h is a through via hole penetrating the first end 10e1 of the main case 10 in the X direction. The movable body case 60 of the movable body MB to be described below is inserted into the first opening 13h (see FIG. 6). A second opening 14h is provided on the end wall 14. The second opening 14h is a through via hole penetrating the end wall 14 in the X direction. A connector 50 of the movable body MB to be described below is inserted into the second opening 14h (see FIG. 6). Hereinafter, for convenience, the second opening 14h is simply referred to as an “opening 14h” in some cases.

Next, a structure provided in the main case 10 will be described. A first protrusion 18 is provided on the first main wall 11 as a first guide. The first protrusion 18 protrudes in the +Z direction toward inside of the main case 10 from an inner surface of the first main wall 11. The first protrusion 18 is, for example, a rib extending in the X direction. The first protrusion 18 is inserted into a first groove 65 of the movable body MB (see FIG. 5). The first protrusion 18 guides linear movement of the movable body MB in the X direction relative to the main case 10.

A second protrusion 19 is provided on the second main wall 12 as a second guide. The second protrusion 19 protrudes in the −Z direction toward inside of the main case 10 from an inner surface of the second main wall 12. The second protrusion 19 is, for example, a rib extending in the X direction. The second protrusion 19 is inserted into a second groove 66 of the movable body MB (see FIG. 5). The second protrusion 19 guides linear movement of the movable body MB in the X direction relative to the main case 10.

Shapes of the first protrusion 18 and the second protrusion 19 are not limited to the above-described examples. For example, the first protrusion 18 and the second protrusion 19 may have a cylindrical shape in which a cross-sectional shape on an XY plane is elliptical, or a columnar shape in which a cross-sectional shape on an XY plane is square.

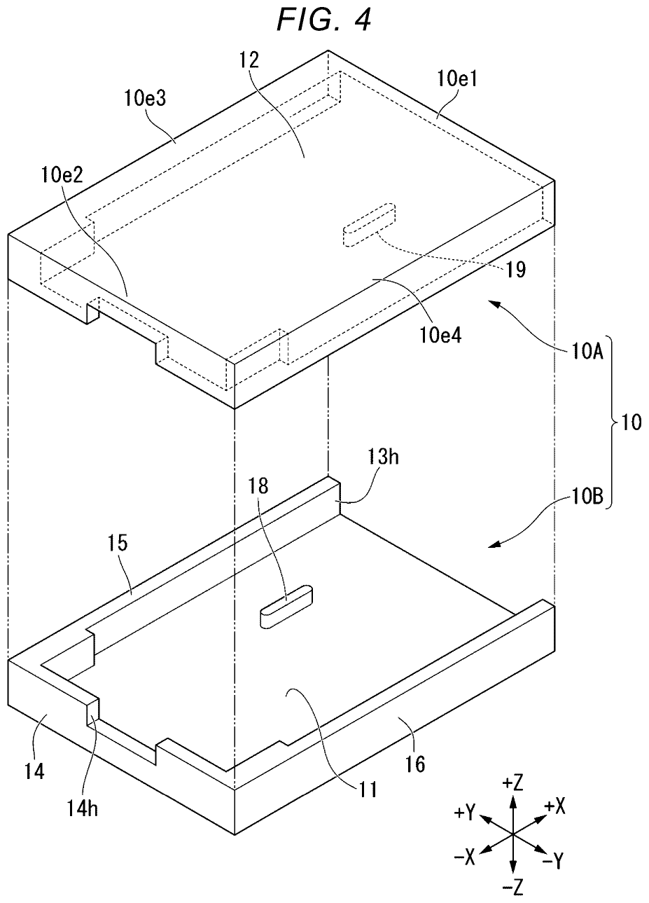

FIG. 4 is an exploded perspective view illustrating the main case 10. In the embodiment, the main case 10 includes a first member 10A and a second member 10B. The first member 10A includes, for example, the second main wall 12, a part of the end wall 14, a part of the first side wall 15, and a part of the second side wall 16. The second member 10B includes, for example, the first main wall 11, a part of the end wall 14, a part of the first side wall 15, and a part of the second side wall 16. One or more among the end wall 14, the first side wall 15, and the second side wall 16 may be provided in only one of the first member 10A and the second member 10B. In the embodiment, the first member 10A and the second member 10B are combined to form the main case 10.

The first member 10A and the second member 10B are joined by ultrasonic bonding or the like. Instead, the first member 10A and the second member 10B may be fixed by a configuration similar to that of a first engagement portion 67 and a second engagement portion 68 illustrated in FIG. 5. It should be noted that a method of fixing the first member 10A and the second member 10B is not limited to the above-described example.

A shape or a structure of the main case 10 is not limited to the above-described example. For example, the main case 10 may be formed by a cylindrical member. The details thereof will be described below.

### 3. Movable Body

Next, the movable body MB will be described. FIG. 5 is a partially exploded perspective view illustrating the movable body MB. The movable body MB is a structure that is movable relative to the main case 10. The movable body MB includes, for example, the substrate 30, the connector 50, and the movable body case 60.

### 3.1 Substrate

The substrate 30 is a plate member extending along the X direction and the Y direction. The substrate 30 is a printed substrate and includes an insulating base and a wiring pattern provided on the insulating base. The substrate 30 includes a first surface 30a and the second surface 30b. Each of the first surface 30a and the second surface 30b extends in the X direction and the Y direction. The first surface 30a is oriented in the −Z direction. The second surface 30b is located on a side opposite to the first surface 30a and oriented in the +Z direction.

The substrate 30 includes the first end 30e1, the second end 30e2, the third end 30e3, and the fourth end 30e4. The first end 30e1 is an end in the +X direction. The second end 30e2 is located on a side opposite to the first end 30e1. The second end 30e2 is an end in the −X direction. The third end 30e3 is an end in the +Y direction. The fourth end 30e4 is located on a side opposite to the third end 30e3. The fourth end 30e4 is an end in the −Y direction.

The substrate 30 includes a plurality of attaching portions 30h. The attaching portions 30h are notches penetrating the substrate 30 in the Z direction. The plurality of attaching portions 30h include, for example, an attaching portion 30hA and an attaching portion 30hB. The attaching portion 30hA is provided at an end of the substrate 30 in the +Y direction. The attaching portion 30hA is a notch recessed in the −Y direction from an edge of the substrate 30 in the +Y direction. Meanwhile, the attaching portion 30hB is provided at an end of the substrate 30 in the −Y direction. The attaching portion 30hB is a notch recessed in the +Y direction from an edge of the substrate 30 in the −Y direction. A protrusion 64 to be described below passes each attaching portion 30h. It should be noted that the attaching portion 30h is not limited to the above-described example. For example, the attaching portion 30h may be a through via hole that penetrates the substrate 30 in the Z direction.

For example, a controller 41 and a NAND flash memory 42 (hereinafter referred to as a “NAND package 42”) are mounted on the substrate 30.

The controller 41 is a component that integrally controls the entire semiconductor storage device 1. The controller 41 is, for example, a semiconductor package that includes a host interface circuit with a host device connected via the connector 50 and a system on a chip (SoC) in which a control circuit or the like controlling the NAND package 42 is integrated on one semiconductor chip. The controller 41 is mounted on, for example, the second surface 30b of the substrate 30.

The NAND package 42 is a semiconductor package including a nonvolatile semiconductor memory chip. The NAND package 42 is an example of a “semiconductor memory”. It should be noted that the “semiconductor memory” is not limited to a NAND flash memory and may be a memory of another type such as a NOR memory, a magnetoresistive random access memory (MRAM), or a variable resistance memory. The NAND package 42 is mounted on, for example, the second surface 30b of the substrate 30. Instead of the above-described example, a semiconductor package in which the controller 41 and the NAND package 42 are integrated may be mounted on the substrate 30. The semiconductor package is an example of a “semiconductor memory”.

### 3.2 Connector

The connector 50 is a connection terminal that conforms with a USB standard. The connector 50 includes, for example, a connector substrate 51 and a metal shell 52. The connector substrate 51 includes, for example, a plurality of metal terminals 51a. The metal terminal 51a is provided on a surface of the connector substrate 51. The metal shell 52 is a shield member that surrounds the connector substrate 51.

The connector 50 is provided at the second end 30e2 of the substrate 30. The connector 50 protrudes in the −X direction from the second end 30e2 of the substrate 30. The connector 50 is attached to, for example, the second surface 30b of the substrate 30 and electrically connected to the wiring pattern of the substrate 30.

### 3.3 Movable Body Case

Next, referring back to FIG. 2, the movable body case 60 will be described. The movable body case 60 accommodates at least a part of the substrate 30. The movable body case 60 holds the substrate 30. The movable body case 60 is an example of a “second case”. The movable body case 60 includes, for example, a case body 61 and a protrusion portion 62.

### Case Body

First, the case body 61 will be described. The case body 61 is a portion that accommodates most of the substrate 30. The case body 61 has a flat box shape extending along the X direction and the Y direction.

The case body 61 includes a first end 61e1, a second end 61e2, a third end 61e3, and a fourth end 61e4. The first end 61e1 is an end of the case body 61 in the +X direction. The second end 61e2 is located on a side opposite to the first end 61e1. The second end 61e2 is an end of the case body 61 in the −X direction. The third end 61e3 is an end of the case body 61 in the +Y direction. The fourth end 61e4 is located on a side opposite to the third end 61e3. The fourth end 61e4 is an end in the −Y direction.

The case body 61 includes a first wall 61a, a second wall 61b, a third wall 61c, a fourth wall 61d, a fifth wall 61e, and a sixth wall 61f. Each of the first wall 61a and the second wall 61b is a wall extending along the X direction and the Y direction. Each of the first wall 61a and the second wall 61b is larger than the third wall 61c, the fourth wall 61d, the fifth wall 61e, and the sixth wall 61f. The first wall 61a is oriented in the −Z direction. The second 61b is located on a side opposite to the first wall 61a and oriented in the +Z direction.

Each of the third wall 61c and the fourth wall 61d is a wall extending along the Y direction and the Z direction. The third wall 61c is located at the first end 61e1 of the case body 61 and oriented in the +X direction. The fourth wall 61d is located at the second end 61e2 of the case body 61 and oriented in the −X direction. Each of the fifth wall 61e and the sixth wall 61f is a wall extending along the X direction and the Z direction. The fifth wall 61e is located at the third end 61e3 of the case body 61 and oriented in the +Y direction. The sixth wall 61f is located at the fourth end 61e4 of the case body 61 and oriented in the −Y direction.

Next, a structure provided in the case body 61 will be described with reference to FIG. 5. A plurality of protrusions 64 to which the substrate 30 is fixed are provided on an inner surface of the first wall 61a (that is, a surface in the +Z direction). The protrusion 64 overlaps the attaching portion 30h when viewed in the Z direction. The plurality of protrusions 64 include, for example, a protrusion 64A and a protrusion 64B.

For example, the protrusion 64A protrudes in the −Y direction from an inner surface of the fifth wall 61e. The protrusion 64A includes, for example, a body portion Pm protruding in the −Y direction from the inner surface of the fifth wall 61e, a protrusion portion Pa protruding in the +X direction from a surface of the body portion Pm in the +X direction, and a protrusion portion Pb protruding in the −X direction from a surface of the body portion Pm in the −X direction. The protrusion 64A engages with the attaching portion 30hA of the substrate 30. For example, the protrusion portions Pa and Pb of the protrusion 64A are brought into contact with an inner surface of the attaching portion 30h of the substrate 30. Accordingly, the substrate 30 is fixed to the protrusion 64A.

Meanwhile, the protrusion 64B protrudes in the +Y direction from an inner surface of the sixth wall 61f. The protrusion 64B includes, for example, a body portion Pm protruding in the +Y direction from the inner surface of the sixth wall 61f, a protrusion portion Pa protruding in the +X direction from a surface of the body portion Pm in the +X direction, and a protrusion portion Pb protruding in the −X direction from a surface of the body portion Pm in the −X direction. The protrusion 64B engages with the attaching portion 30hB of the substrate 30. For example, the protrusion portions Pa and Pb of the protrusion 64B are brought into contact with an inner surface of the attaching portion 30h of the substrate 30. Accordingly, the substrate 30 is fixed to the protrusion 64B.

In the embodiment, the protrusions 64A and 64B engage with the attaching portions 30hA and 30hB of the substrate 30 so that the substrate 30 is fixed to the movable body case 60. Accordingly, the substrate 30 is held by the movable body case 60.

A method of fixing the substrate 30 to the movable body case 60 is not limited to the above-described example. For example, the substrate 30 may be fixed to the movable body case 60 by a protrusion provided on the first wall 61a or the second wall 61b of the movable body case 60 engaging with the attaching portion 30h of the substrate 30.

A plurality of pedestals for adjusting a position of the substrate 30 in the Z direction may be further provided on an inner surface of the first wall 61a. The plurality of pedestals may be provided near the protrusion 64A and the protrusion 64B and/or in four corners of a first member 60A.

The first groove 65 is provided on an outer surface of the first wall 61a (that is, a surface in the −Z direction). The first groove 65 is recessed in the +Z direction from the surface of the first wall 61a in the −Z direction. The first groove 65 extends in the X direction. The first protrusion 18 provided on an inner surface of the main case 10 (see FIG. 4) is inserted into the first groove 65. The first groove 65 guides linear movement of the movable body MB in the X direction relative to the main case 10.

The second groove 66 is provided on an outer surface of the second wall 61b (that is, a surface in the +Z direction). The second groove 66 is recessed in the −Z direction from the surface of the second wall 61b in the +Z direction. The second groove 66 extends in the X direction. The second protrusion 19 provided on an inner surface of the main case 10 (see FIG. 4) is inserted into the second groove 66. The second groove 66 guides linear movement of the movable body MB in the X direction relative to the main case 10.

### Protrusion Portion

Next, the protrusion portion 62 will be described. The protrusion portion 62 is a portion protruding in the −X direction from the second end 61e2 of the case body 61. The protrusion portion 62 covers a part of the connector 50. For example, the protrusion portion 62 covers a connection portion between the connector 50 and the substrate 30 from a side opposite to the connector 50. In the embodiment, the protrusion portion 62 is formed in a U shape opened in the +Z direction. The protrusion portion 62 covers the connection portion between the connector 50 and the substrate 30 from three directions of the −Z, +Y, and −Y directions.

In the embodiment, a width W2 of the protrusion portion 62 in the Y direction is less than a width W1 of the case body 61 in the Y direction (for example, a width of the second end 61e2 of the case body 61 in the Y direction). Therefore, in a boundary between the case body 61 and the protrusion portion 62, a step difference ST occurs due to a difference between the width W1 of the case body 61 in the Y direction and the width W2 of the protrusion portion 62 in the Y direction. The step difference ST is formed by, for example, the fourth wall 61d of the case body 61 described above.

In the embodiment, the fourth wall 61d includes a first end wall 61da and a second end wall 61db. The first end wall 61da is a wall extending along the Y direction and the Z direction. The first end wall 61da is provided between the protrusion portion 62 and the fifth wall 61e of the case body 61. The first end wall 61da is oriented in the −X direction and forms the step difference ST described above. Similarly, the second end wall 61db is a wall extending along the Y direction and the Z direction. The second end wall 61db is provided between the protrusion portion 62 and the sixth wall 61f of the case body 61. The second end wall 61db is oriented in the −X direction and forms the step difference ST described above.

### Assembly Structure of Movable Body Case 60

Next, an assembly structure of the movable body case 60 will be described. In the embodiment, the movable body case 60 includes the first member 60A and a second member 60B. The first member 60A includes, for example, the first wall 61a, the third wall 61c, the fourth wall 61d, the fifth wall 61e, the sixth wall 61f, and the protrusion portion 62. The first member 60A also includes a plurality of first engagement portions 67. The first engagement portion 67 is, for example, a claw provided in the first member 60A.

The second member 60B includes, for example, the second wall 61b. The second member 60B includes a plurality of second engagement portions 68. The second engagement portion 68 is, for example, a reception portion that receives the first engagement portion 67. The first member 60A and the second member 60B are fixed by the second engagement portion 68 engaging with the first engagement portion 67. In the embodiment, the movable body case 60 is formed by combining the first member 60A and the second member 60B. The first member 60A and the second member 60B may be joined by ultrasonic bonding.

A shape and a structure of the movable body case 60 are not limited to the above-described example. For example, the movable body case 60 may be formed by a cylindrical member.

### 3.4 Movement Aspect of Movable Body

Next, a movement aspect of the movable body MB will be described. The movable body MB is movable relative to the main case 10 between at least a first position at which the connector 50 is accommodated inside the main case 10 and a second position at which the connector 50 protrudes outward from the opening 14h of the main case 10. For example, the movable body MB is movable by sliding in the X direction relative to the main case 10.

FIG. 6 is a sectional view illustrating the movable body MB located at the first position. The first position is a position corresponding to a non-using state of the semiconductor storage device 1. When the movable body MB is located at the first position, the connector 50 is accommodated inside the main case 10 without protruding outward from the second opening 14h of the main case 10. When the movable body MB is located at the first position, a part of the movable body MB (for example, the movable body case 60) protrudes outward from the first opening 13h of the main case 10. For example, the first end 61e1 of the movable body case 60 protrudes toward outside of the main case 10.

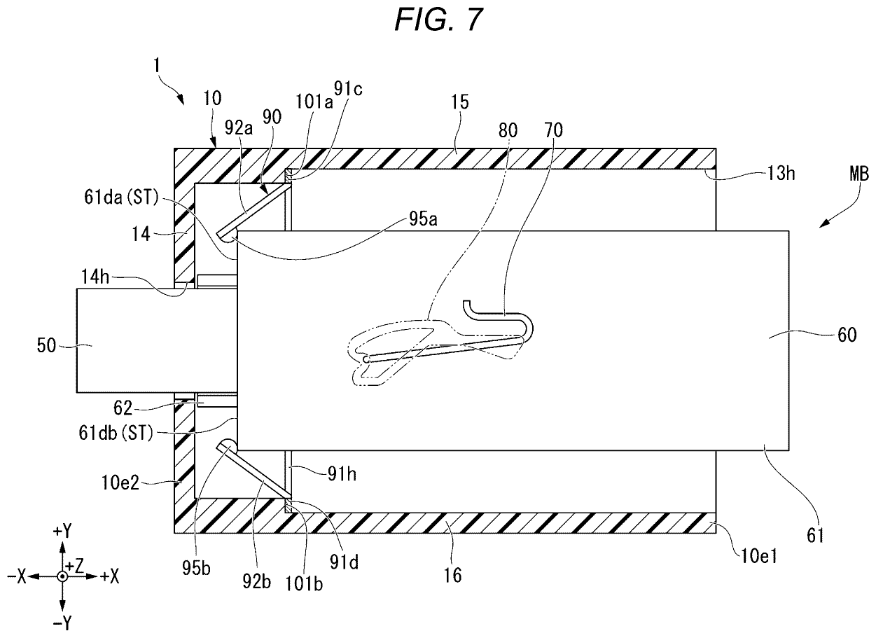

FIG. 7 is a sectional view illustrating the movable body MB located at the second position. The second position is a position corresponding to a using state of the semiconductor storage device 11. The second position is a position to which the movable body MB was moved in the −X direction from the first position relative to the main case 10. When the movable body MB is located at the second position, the connector 50 protrudes toward outside of the main case 10 from the opening 14h of the main case 10, and can be connected to an external host device. When the movable body MB is located at the second position, a part of the movable body MB (for example, a part of the movable body case 60) protrudes outward from the first opening 13h of the main case 10. It should be noted that a protrusion amount of the movable body case 60 protruding toward outside of the main case 10 at the second position is less than a protrusion amount of the movable body case 60 protruding toward outside of the main case 10 at the first position.

### 4. Position Support Member

Next, referring back to FIG. 2, the position support member 70 will be described. In a knock slide type USB memory, the position support member 70 holds the movable body MB at the second position when the movable body MB is pushed once in the −X direction and moved from the first position to the second position. When the movable body MB held at the second position is pushed once more in the −X direction, the position support member 70 releases holding of the movable body MB at the second position and allows movement of the movable body MB toward the first position. The position support member 70 is, for example, a spring member and can be elastically deformed.

The position support member 70 is provided between the main case 10 and the movable body MB. Hereinafter, an example in which the position support member 70 is attached to the movable body MB will be described. As will be described below, the position support member 70 may be attached to the main case 10 instead of the movable body MB. The position support member 70 includes, for example, a fixing portion 71, an arc portion 72, a straight portion 73, and an engagement portion 74.

The fixing portion 71 is fixed to the movable body MB by a fixing tool, an adhesive, or another fixing mechanism. For example, the fixing portion 71 is fixed to the movable body case 60. The arc portion 72 is a curved portion that has an arc shape connected to the fixing portion 71. The straight portion 73 to be described below is allowed to move in the Y direction relative to the fixing portion 71 by elastically deforming the arc portion 72.

The straight portion 73 is located on a side opposite to the fixing portion 71 relative to the arc portion 72. The straight portion 73 is connected to the arc portion 72. The straight portion 73 extends linearly in the X direction. The engagement portion 74 is provided at a tip of the straight portion 73. The engagement portion 74 is a protrusion protruding in the +Z direction toward inside of the main case 10 from the straight portion 73. The engagement portion 74 is inserted into a groove 80 provided on the inner surface of the main case 10 as to be described below (see FIGS. 6 and 7). The engagement portion 74 moves inside the groove 80 while being guided by an inner surface of the groove 80 when the movable body MB moves in the X direction relative to the main case 10.

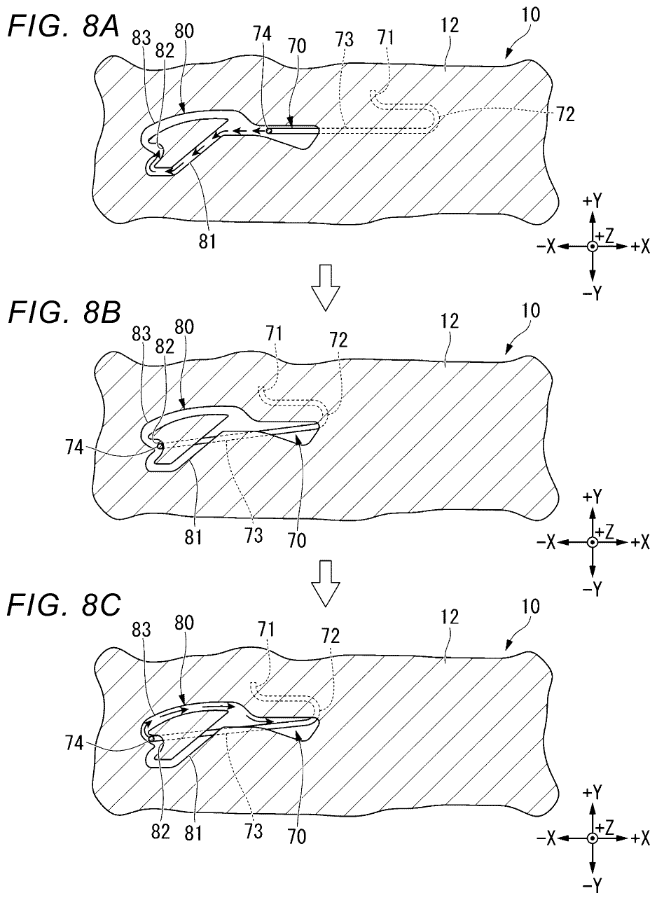

FIGS. 8A to 8C are sectional views illustrating movement of the position support member 70. The inner surface of the main case 10 includes the groove 80 for guiding and holding the position support member 70. The groove 80 includes, for example, a first passage 81, a holding portion 82, and a second passage 83.

The first passage 81 is a passage that guides the engagement portion 74 when the movable body MB is pushed and moved in the −X direction that is a direction oriented from the first position to the second position. The first passage 81 includes, for example, a portion extending in a direction inclined in the −Y direction relative to the X direction. An end of the first passage 81 in the −X direction is folded in the +X direction and connected to the holding portion 82. The first passage 81 guides the engagement portion 74 of the position support member 70 toward the holding portion 82 (see an arrow in FIG. 8A) when the movable body MB is pushed in the −X direction and moved from the first position to the second position.

The holding portion 82 is a groove provided between the first passage 81 and the second passage 83 and recessed in the +X direction. When the movable body MB moves to the second position, the engagement portion 74 of the position support member 70 passes the first passage 81, reaches the holding portion 82, and engages with the holding portion 82. When the engagement portion 74 of the position support member 70 engages with the holding portion 82 (that is, when the position support member 70 engages with the main case 10) movement of the movable body MB in the +X direction relative to the main case 10 is regulated. Accordingly, the movable body MB is held at the second position (see FIG. 8B).

The second passage 83 is a passage that guides the engagement portion 74 of the position support member 70 when the movable body MB held at the second position is pushed once more in the −X direction to move from the second position to the first position. The second passage 83 includes, for example, a portion extending in a direction inclined in the +Y direction relative to the X direction. An end of the second passage 83 in the −X direction extends in the −X direction from the holding portion 82 and is folded in the +X direction. By such configuration, when the movable body MB held at the second position is pushed once more in the −X direction, engagement of the engagement portion 74 of the position support member 70 with the holding portion 82 (that is, engagement of the position support member 70 with the main case 10) is released. The second passage 83 guides the engagement portion 74 of the position support member 70 toward an initial position corresponding to the first position when the movable body MB held at the second position is pushed once more and engagement is released (see an arrow in FIG. 8C).

### 5. Plate Spring

Next, referring back to FIG. 2, the plate spring 90 will be described. The plate spring 90 is a spring member that biases the movable body MB located at the second position to return the movable body MB to the first position. The plate spring 90 is formed of, for example, general spring steel. Here, a material of the plate spring 90 is not particularly limited.

In the embodiment, the plate spring 90 is provided between the main case 10 and the movable body MB. The plate spring 90 biases the movable body MB toward the first position at least when the movable body MB is held at the second position. The plate spring 90 moves the movable body MB toward the first position when engagement of the position support member 70 with the main case 10 is released.

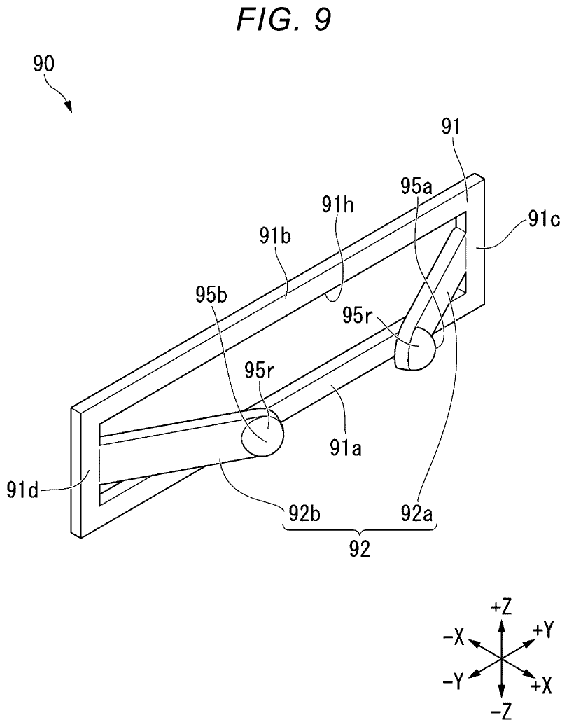

FIG. 9 is a perspective view illustrating the plate spring 90. The plate spring 90 includes, for example, a frame 91 and a biasing portion 92.

### 5.1 Frame

The frame 91 is a support body that supports the biasing portion 92. The frame 91 is formed in a frame shape that includes an opening 91h through which at least a part of the movable body MB can be inserted in the X direction. The frame 91 has, for example, a rectangular frame shape. For example, the connector 50 can be inserted in the X direction inside the frame 91 (that is, the opening 91h of the frame 91). For example, the protrusion portion 62 of the movable body case 60 can be inserted in the X direction inside the frame 91 (that is, the opening 91h of the frame 91). In the embodiment, the case body 61 of the movable body case 60 can also be inserted in the X direction inside the frame 91 (that is, the opening 91h of the frame 91).

The frame 91 includes, for example, a first portion 91a, a second portion 91b, a third portion 91c, and a fourth portion 91d. The opening 91h is provided between the first portion 91a, the second portion 91b, the third portion 91c, and the fourth portion 91d.

The first portion 91a is located at an end of the frame 91 in the −Z direction. The first portion 91a extends in the Y direction. The second portion 91b is located at an end of the frame 91 in the +Z direction. The second portion 91b extends in the Y direction.

The third portion 91c is located at an end of the frame 91 in the +Y direction. The third portion 91c extends in the Z direction. The third portion 91c connects an end of the first portion 91a in the +Y direction to an end of the second portion 91b in the +Y direction. The fourth portion 91d is located at an end of the frame 91 in the −Y direction. The fourth portion 91d extends in the Z direction. The fourth portion 91d connects an end of the first portion 91a in the −Y direction to an end of the second portion 91b in the −Y direction.

### 5.2 Biasing Portion

The biasing portion 92 is provided inside the frame 91 and supported by the frame 91. The biasing portion 92 protrudes from the frame 91 and can be elastically deformed in the X direction relative to the frame 91. The biasing portion 92 is brought into contact with the movable body MB and biases the movable body MB toward the first position.

In the embodiment, the biasing portion 92 includes a pair of plate portions 92a and 92b. The pair of plate portions 92a and 92b are each disposed on both sides of the movable body MB in the Y direction to be brought into contact with the movable body MB.

For example, the plate portion 92a protrudes toward inside of the frame 91 from a middle portion of the third portion 91c of the frame 91 in the Z direction. The plate portion 92a is supported by the third portion 91c of the frame 91 and can be elastically deformed in the X direction relative to the third portion 91c of the frame 91. The plate portion 92a is brought into contact with the first end wall 61da of the case body 61 formed by the step difference ST of the movable body MB in the −X direction In other words, the plate portion 92a bend in the +X direction relative to the frame 91(see FIG. 6).

For example, the plate portion 92b protrudes toward inside of the frame 91 from a middle portion of the fourth portion 91d of the frame 91 in the Z direction. The plate portion 92b is supported by the fourth portion 91d of the frame 91 and can be elastically deformed in the X direction relative to the fourth portion 91d of the frame 91. The plate portion 92a is brought into contact with the second end wall 61db of the case body 61 formed by the step difference ST of the movable body MB in the −X direction In other words, the plate portion 92b bend in the +X direction relative to the frame 91. (see FIG. 6).

### 5.2.1 Biasing State for Movable Body at First Position

As illustrated in FIG. 6, the plate portions 92a and 92b of the biasing portion 92 are not elastically deformed or are only slightly elastically deformed when the movable body MB is located at the first position. In the embodiment, the plate portions 92a and 92b of the biasing portion 92 are brought into gentle contact in the −X direction with the movable body MB located at the first position to slightly bias the movable body MB in the +X direction. It should be noted that the biasing portion 92 may not be brought into contact with the movable body MB located at the first position.

### 5.2.2 Biasing State for Movable Body at Second Position

As illustrated in FIG. 7, the plate portions 92a and 92b of the biasing portion 92 are more greatly elastically deformed when the movable body MB is located at the second position than when the movable body MB is located at the first position. In the embodiment, a deformation amount of the plate portions 92a and 92b of the biasing portion 92 due to elastic deformation increases as the movable body MB moves from the first position to the second position. That is, the biasing portion 92 increases a biasing force that biases the movable body MB in the +X direction as the movable body MB moves from the first position to the second position.

For example, the plate portions 92a and 92b of the biasing portion 92 are brought into contact with the movable body MB located at the second position and bias the movable body MB in the +X direction. For example, the plate portions 92a and 92b of the biasing portion 92 are brought into strong contact in the −X direction with the movable body MB located at the second position and strongly bias the movable body MB in the +X direction than when the movable body MB is located at the first position.

In the embodiment, when the movable body MB is located at the second position, the plate portions 92a and 92b of the biasing portion 92 bias the movable body MB in the +X direction while the engagement portion 74 of the position support member 70 is engaged with the holding portion 82 of the groove 80. Accordingly, engagement of the engagement portion 74 of the position support member 70 with the holding portion 82 of the groove 80 becomes stronger. Accordingly, until the movable body MB is pushed once more in the −X direction, an engaging state of the engagement portion 74 of the position support member 70 with the holding portion 82 of the groove 80 is maintained.

The plate portions 92a and 92b of the biasing portion 92 move the movable body MB from the second position to the first position when the movable body MB held at the second position is pushed once more in the −X direction and engagement of the position support member 70 with the main case 10 is released. For example, the plate portions 92a and 92b of the biasing portion 92 move the movable body MB to the first position when engagement of the position support member 70 with the main case 10 is released. In the embodiment, for example, the plate portions 92a and 92b of the biasing portion 92 are continuously brought into contact with the movable body MB in the −X direction and continuously bias the movable body MB in the +X direction from a state in which the movable body MB is held at the second position until the movable body MB reaches the first position.

### 5.2.3 Deformation Aspect of Biasing Portion

In the embodiment, each of the plate portions 92a and 92b of the biasing portion 92 can be elastically deformed relative to the frame 91 in the +X direction and the −X direction, respectively. For example, when the movable body MB is located at the first position, the plate portions 92a and 92b of the biasing portion 92 are located in the +X direction relative to the frame 91 (that is, on a side closer to the first end 61e1 of the movable body case 60 when viewed from the frame 91) (see FIG. 6). Meanwhile, when the movable body MB is located at the second position, the plate portions 92a and 92b of the biasing portion 92 are located in the −X direction relative to the frame 91 (that is, on a side closer to the second end 61e2 of the movable body case 60 when viewed from the frame 91) (see FIG. 7).

### 5.2.4 Shape of Tip of Biasing Portion

In the embodiment, the biasing portion 92 includes contact portions 95a and 95b provided at a tip of the biasing portion 92 (see FIGS. 6 and 7). For example, the contact portion 95a is provided at a tip of the plate portion 92a. The contact portion 95b is provided at a tip of the plate portion 92b. Each of the contact portions 95a and 95b has a curved surface 95r brought into contact with the movable body MB so that a contact area between the biasing portion 92 and the movable body MB becomes smaller (for example, so that point contact is made). For example, each of the contact portions 95a and 95b is formed in a hemisphere shape.

### 5.2.5 Support Structure for Plate Spring

As illustrated in FIG. 6, the inner surface of the main case 10 includes support portions 101a and 101b that support the frame 91 of the plate spring 90. The support portion 101a is, for example, a stepped portion provided on the first side wall 15 of the main case 10 and oriented in the +X direction. The support portion 101b is, for example, a stepped portion provided on the second side wall 16 of the main case 10 and oriented in the +X direction.

The support portions 101a and 101b overlap the frame 91 of the plate spring 90 when viewed in the X direction and support the frame 91 in the −X direction. For example, the support portions 101a and 101b are brought into contact with the frame 91 in the −X direction to regulate movement of the frame 91 in the −X direction. In the embodiment, the plate spring 90 is interposed between the support portions 101a and 101b of the main case 10 and the end walls 61da and 61db of the movable body MB in the X direction inside the main case 10.

### 6. Operation

6.1 Transition from Non-Using State to Using State of

In a non-using state of the semiconductor storage device 1, the movable body MB is located at the first position and the connector 50 is accommodated inside the main case 10. Then, when the first end 61e1 of the movable body case 60 is pushed in the −X direction by a user, the movable body MB moves in the −X direction while elastically deforming the plate spring 90 against a biasing force of the plate spring 90. Here, as the movable body MB moves in the −X direction, the engagement portion 74 of the position support member 70 is guided along the first passage 81 of the groove 80 and moved toward the holding portion 82. When the movable body MB moves to the second position, the engagement portion 74 of the position support member 70 engages with the holding portion 82 of the groove 80 while the movable body MB is biased in the +X direction by the plate spring 90. Accordingly, even when the user releases their hand from the semiconductor storage device 1, the movable body MB remains held at the second position. Accordingly, transition of the semiconductor storage device 1 into the using state is completed.

6.2 Transition from Using State to Non-Using State

When causing the semiconductor storage device 1 to transition from the using state to the non-using state, the user pushes the first end 61e1 of the movable body case 60 once more in the −X direction. When the user pushes the first end 61e1 of the movable body case 60 once more in the −X direction, the movable body MB moves in the −X direction against the biasing force of the plate spring 90 and engagement of the engagement portion 74 of the position support member 70 with the holding portion 82 of the groove 80 is released. Accordingly, the engagement portion 74 of the position support member 70 moves along the second passage 83 of the groove 80 and the movable body MB can move toward the first position.

Here, when the user releases their force, the movable body MB moves toward the first position by the biasing force of the plate spring 90. When the movable body MB moves to the first position, for example, ends of the grooves 65 and 66 of the movable body MB in the −X direction are brought into contact with the protrusions 18 and 19 of the main case 10 so that further movement of the movable body MB in the +X direction is regulated. Accordingly, even when the user releases their hand from the semiconductor storage device 1, the movable body MB is held at the first position. Accordingly, transition of the semiconductor storage device 1 into the non-using state is completed.

### 7. Advantages

As a comparative example, a configuration in which a coil spring that biases the movable body MB toward the first position is provided instead of the plate spring 90 will be described. In the configuration of the comparative example, a part of the movable body MB is inserted inside the coil spring. In general, the coil spring is attached so that a gap causing a position or a posture of the coil spring to be unstable is reduced and the movable body MB is stably moved. Here, an inner circumferential surface of the coil spring and a part of the movable body MB are easily brought into contact with each other.

Accordingly, when the movable body MB moves from the first position to the second position and the coil spring is compressed, a part of the movable body MB may be caught between coils of the coil spring and/or a part of the movable body MB may slide along the coil spring. When a part of the movable body MB is caught between coils of the coil spring, it may be difficult for the part of the coil spring to be properly deformed, leading to a decrease in quality of the semiconductor storage device. When the part of the movable body MB slides along the coil spring, the part of the movable body MB may be scraped so that shavings occur inside the semiconductor storage device. When shavings are caught between coils of the coil spring, it may be difficult for the coil spring to be properly deformed, leading to a decrease in quality of the semiconductor storage device.

Meanwhile, in the embodiment, the semiconductor storage device 1 includes the main case 10, the movable body MB, the position support member 70, and the plate spring 90. The main case 10 is provided with the opening 14h. The movable body MB includes the substrate 30 on which the NAND package 42 is mounted, the connector 50 provided at one end of the substrate 30, and the movable body case 60 that accommodates at least a part of the substrate 30. The movable body MB can move between at least the first position at which the connector 50 is accommodated inside the main case 10 and the second position at which the connector 50 protrudes outward from the opening 14h. The position support member 70 is provided between the main case 10 and the movable body MB. The position support member 70 engages with the main case 10 at the second position and holds the movable body MB at the second position when the movable body MB is pushed at the first direction and moves from the first position to the second position. When the movable body MB held at the second position is pushed once more in the first direction, engagement of the position support member 70 with the main case 10 is released. The plate spring 90 is provided between the main case 10 and the movable body MB. The plate spring 90 biases the movable body MB toward the first position when the movable body MB is held at the second position. The plate spring 90 moves the movable body MB toward the first position when engagement of the position support member 70 with the main case 10 is released.

In such configuration, it is possible to prevent a part of the movable body MB from being caught between coils of the coil spring and/or a part of the movable body MB from sliding along the coil spring. Therefore, compared to the configuration of the above-described comparative example, the movable body MB can move smoothly relative to the main case 10. It also make it possible to prevent shavings from generating and interfering with the knocking operation. Accordingly, it is possible to achieve improvement in quality of the semiconductor storage device 1.

In the embodiment, the plate spring 90 includes the frame 91 through which at least a part of the movable body MB passes, and the biasing portion 92 that protrudes from the frame 91, is elastically deformed relative to the frame 91, and is brought into contact with the movable body MB and biases the movable body MB toward the first position. According to such configuration, since the biasing portion 92 is more securely held by the frame 91, it is easier to appropriately bias the movable body MB by the biasing portion 92. Accordingly, it is possible to achieve an improve in quality of the semiconductor storage device 1.

The biasing unit 92 includes the pair of plate portions 92a and 92b each disposed on both sides of the movable body MB in the second direction intersecting the first direction and brought into contact with the movable body MB. According to such configuration, since both sides of the movable body MB in the second direction (for example, both sides in the Y direction) are supported, it becomes easier to more appropriately apply the biasing force to the movable body MB. Accordingly, it is possible to achieve further improvement in quality of the semiconductor storage device 1.

In the embodiment, the main case 10 includes the first end 10e1 and the second end 10e2 provided on the side opposite to the first end 10e1 and including the opening 14h. Each of the pair of plate portions 92a and 92b is elastically deformable from both the first side closer to the first end 10e1 in the first direction when viewed from the frame 91 and the second side closer to the second end 10e2 in the first direction when viewed from the frame 91. According to such configuration, it becomes easier to ensure a larger elastic deformation amount of the plate portions 92a and 92b. Accordingly, the movable body MB can be more securely biased toward the first position by the plate spring 90. Accordingly, it is possible to achieve further improvement in quality of the semiconductor storage device 1.

In the embodiment, the biasing portion 92 includes the contact portions 95a and 95b each provided at the tip of the biasing portion 92, having the curved surface 95r, and brought into contact with the movable body MB. When the contact portions 95a and 95b are provided, the contact area between the biasing portion 92 and the movable body MB becomes smaller, so that it is easier to further reduce scrapping of the part of the movable body MB due to sliding along the biasing portion 92. Accordingly, it is possible to achieve further improvement in quality of the semiconductor storage device 1.

In the embodiment, the inner surface of the main case 10 includes the support portions 101a and 101b that overlap the frame 91 when viewed in the first direction described above and support the frame 91. According to such configuration, it is possible to prevent the frame portion 91 from being misaligned in the −X direction and support the urging portion 92 more appropriately by the frame 91. Accordingly, the biasing portion 92 can bias the movable body MB more appropriately. Therefore, it is possible to achieve further improvement in quality of the semiconductor storage device 1.

### 8. Modifications

### 8.1 First Modification

In the above-described embodiment, the position support member 70 is attached to the movable body MB, and the groove 80 is provided on the inner surface of the main case 10. Instead, the position support member 70 may be attached to the inner surface of the main case 10, and the groove 80 may be provided on the movable body MB. Here, when the movable body MB is pushed and moved in the first direction oriented from the first position to the second position, the engagement portion 74 of the position support member 70 engages with the holding portion 82 of the groove 80 of the movable body MB moved to the second position and holds the movable body MB at the second position. When the movable body MB held at the second position is pushed once more in the first direction, engagement with the holding portion 82 of the groove 80 of the movable body MB is released. The plate spring 90 moves the movable body MB toward the first position when the engagement of the position support member 70 with the movable body MB is released.

### 8.2 Second Modification

In the above-described embodiment, the protrusions 18 and 19 are provided on the inner surface of the main case 10 and the grooves 65 and 66 are provided in the movable body MB. Instead, the grooves 65 and 66 may be provided on the inner surface of the main case 10 and the protrusions 18 and 19 may be provided in the movable body MB.

### 8.3 Third Modification

In the above-described embodiment, the biasing portion 92 is brought into contact with the end walls 61da and 61db of the movable body case 60. Instead, when a part of the substrate 30 protrudes toward outside of the movable body case 60, the biasing portion 92 may be brought into contact with the substrate 30 instead of or in addition to the movable body case 60.

### 8.4 Fourth Modification

In the above-described embodiment, the main case 10 includes the first member 10A and the second member 10B. Instead, the main case 10 may be one cylindrical member.

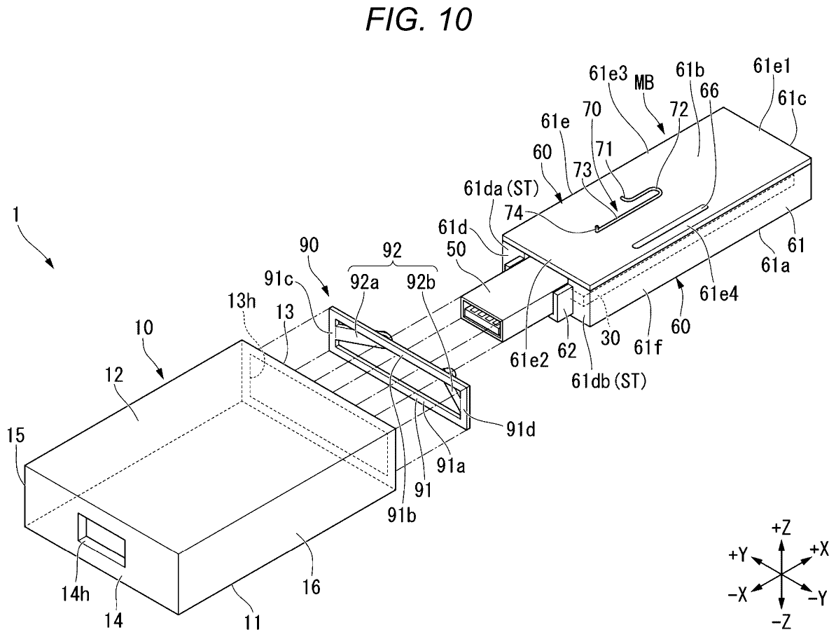

FIG. 10 is a partially exploded perspective view illustrating the semiconductor storage device 1 according to a fourth modification. In the fourth modification, the main case 10 is formed by one cylindrical member. For example, the first main wall 11, the second main wall 12, the end wall 14, the first side wall 15, and the second side wall 16 are included in the one cylindrical member.

### 8.5 Fifth Modification

In the above-described embodiment, the biasing portion 92 is provided in the third portion 91c and the fourth portion 91d of the frame 91. However, the biasing portion 92 is not limited to the above-described example and may be provided at any position of the frame 91 in a circumferential direction (for example, any position within 360 degrees of the circumferential direction).

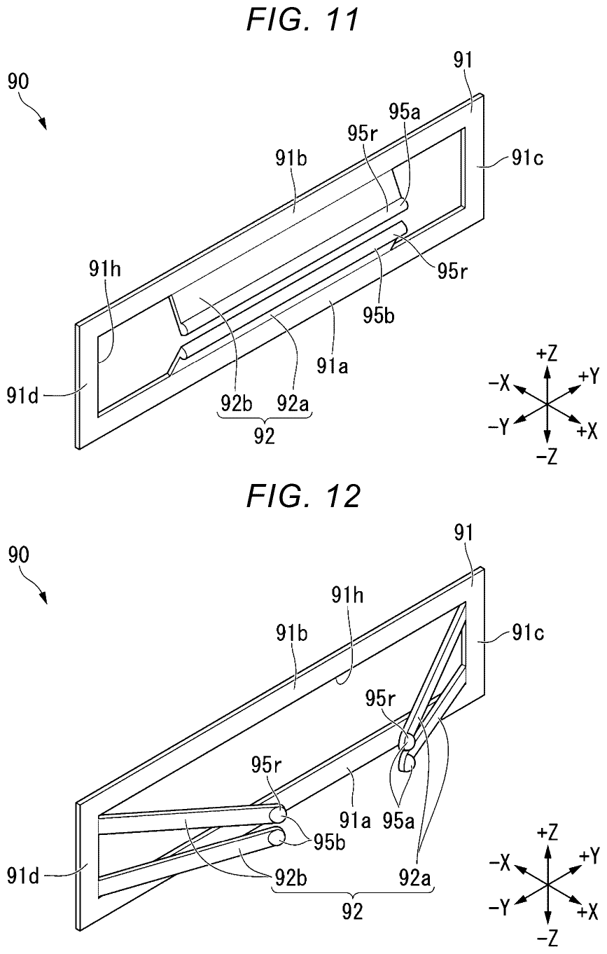

FIG. 11 is a perspective view illustrating an aspect of a plate spring 90 according to a fifth modification. In the example illustrated in FIG. 11, the plate portion 92a of the biasing portion 92 is provided in the first portion 91a of the frame 91. The plate portion 92b of the biasing portion 92 is provided in the second portion 91b of the frame 91. In the example, the above-described contact portions 95a and 95b may be formed linearly in the Y direction.

FIG. 12 is a perspective view illustrating another aspect of the plate spring 90 according to the fifth modification. In the example illustrated in FIG. 12, the plate portion 92a of the biasing portion 92 is provided in one or a plurality of corners (for example, two corners) of the frame 91 in the +Y direction. The plate portion 92b of the biasing portion 92 is provided in one or a plurality of corners (for example, two corners) of the frame 91 in the −Y direction.

The embodiment and the modifications described above are not limited to the above-described examples. For example, the embodiment and modifications described above may be implemented in combination with each other.

According to at least one of the embodiments described above, a semiconductor storage device includes a first case, a movable body, a position support member, and a plate spring. The first case includes an opening. The movable body includes a substrate on which a semiconductor memory is mounted, a connector provided at one end of the substrate, and a second case accommodating at least a part of the substrate. The movable body is movable between at least a first position at which the connector is accommodated inside the first case and a second position at which the connector protrudes outward from the opening. The position support member is provided between the first case and the movable body, and engages with the first case or the movable body at the second position and holds the movable body at the second position when the movable body is pushed and moved in a first direction oriented from the first position to the second position. The position support member releases engagement with the first case or the movable body when the movable body held at the second position is pushed once more in the first direction. The plate spring is provided between the first case and the movable body, biases the movable body toward the first position at least when the movable body is held at the second position, and moves the movable body toward the first position when the engagement of the position support member with the first case or the movable body is released. According to such configuration, it is possible to achieve improvement in quality of the semiconductor storage device.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A semiconductor storage device comprising:
a first case including an opening;
a movable body including a substrate, a connector provided at one end of the substrate, and a second case accommodating at least a part of the substrate, in which the movable body is movable between at least a first position at which the connector is accommodated inside the first case and a second position at which the connector protrudes outward from the opening;
a position support member that is provided between the first case and the movable body, engages with the first case or the movable body at the second position and holds the movable body at the second position when the movable body is pushed and moved from the first position in a first direction oriented from the first position to the second position, and
a plate spring that is provided between the first case and the movable body, selectively biases the movable body toward the first position or moves the movable body toward the first position,
wherein the plate spring biases the movable body at least when the movable body is held at the second position, and moves the movable body toward the first position when the engagement of the position support member with the first case or the movable body is released.

2. The semiconductor storage device according to claim 1, wherein the position support member releases engagement with the first case or the movable body when the movable body held at the second position is pushed from the second position in the first direction.

3. The semiconductor storage device according to claim 1, wherein
the plate spring includes a frame that includes an opening through which at least a part of the movable body passes and a biasing portion that protrudes from the frame, and
the plate spring is elastically deformable relative to the frame, and is in contact with the movable body and biases the movable body toward the first position.

4. The semiconductor storage device according to claim 3, wherein an inner surface of the first case includes a support portion that overlaps the frame when viewed in the first direction and supports the frame.

5. The semiconductor storage device according to claim 3, wherein
the movable body has a first side and a second side, and
the biasing portion includes a pair of plate portions that are respectively disposed on the first side and the second side of the movable body in a second direction intersecting the first direction and are in contact with the movable body.

6. The semiconductor storage device according to claim 3, wherein the biasing portion includes a contact portion that is provided at a tip of the biasing portion, including a curved surface, and is in contact with the movable body.

7. The semiconductor storage device according to claim 5, wherein
the first case includes a first end and a second end that is located on a side opposite to the first end and is provided with the opening, and
each of the pair of plate portions is elastically deformable relative to the frame from a first side closer to the first end than to the second end in the first direction when viewed from the frame.

8. The semiconductor storage device according to claim 7, wherein each of the pair of plate portions is elastically deformable relative to the frame from a second side closer to the second end than to the first end in the first direction when viewed from the frame.

9. A semiconductor storage device comprising:
a first case including an opening;
a movable body including a substrate, a connector provided at one end of the substrate, and a second case accommodating at least a part of the substrate, in which the movable body is movable between at least a first position at which the connector is accommodated inside the first case and a second position at which the connector protrudes outward from the opening; and
a plate spring that is provided between the first case and the movable body, selectively biases the movable body toward the first position or moves the movable body toward the first position, wherein
the plate spring biases the movable body at least when the movable body is held at the second position,
the plate spring includes a frame that includes an opening through which at least a part of the movable body passes and a biasing portion that protrudes from the frame, and
the plate spring is elastically deformable relative to the frame, and is in contact with the movable body and biases the movable body toward the first position.

10. The semiconductor storage device according to claim 9, wherein the biasing portion includes a contact portion that is provided at a tip of the biasing portion, including a curved surface, and is in contact with the movable body.

11. The semiconductor storage device according to claim 9, further comprising:
a position support member that is provided between the first case and the movable body, engages with the first case or the movable body at the second position and holds the movable body at the second position when the movable body is pushed and moved from the first position in a first direction oriented from the first position to the second position.

12. The semiconductor storage device according to claim 11, wherein the position support member releases engagement with the first case or the movable body when the movable body held at the second position is pushed from the second position in the first direction.

13. The semiconductor storage device according to claim 11, wherein an inner surface of the first case includes a support portion that overlaps the frame when viewed in the first direction and supports the frame.

14. The semiconductor storage device according to claim 11, wherein
the movable body has a first side and a second side, and
the biasing portion includes a pair of plate portions that are respectively disposed on the first side and the second side of the movable body in a second direction intersecting the first direction and are in contact with the movable body.

15. The semiconductor storage device according to claim 14, wherein
the first case includes a first end and a second end that is located on a side opposite to the first end and is provided with the opening, and
each of the pair of plate portions is elastically deformable relative to the frame from a first side closer to the first end than to the second end in the first direction when viewed from the frame.

16. The semiconductor storage device according to claim 15, wherein each of the pair of plate portions is elastically deformable relative to the frame from a second side closer to the second end than to the first end in the first direction when viewed from the frame.

17. A semiconductor storage device comprising:
a first case including an opening;
a movable body including a semiconductor memory and a connector, wherein the movable body is movable between at least a first position at which the connector is contained within the first case and a second position at which the connector protrudes outward from the opening;
a position support member configured to selectively, engages with the first case or the movable body and holds the movable body at the second position, or releases the engagement with the first case or the movable body, and
a plate spring that is provided between the first case and the movable body, and selectively biases the movable body toward the first position or moves the movable body toward the first position,
wherein the plate spring biases the movable body toward the first position at least when the movable body is held at the second position, and moves the movable body toward the first position when the engagement of the position support member with the first case or the movable body is released.

18. The semiconductor storage device according to claim 17, wherein the position support member releases engagement with the first case or the movable body when the movable body held at the second position is pushed from the second position in the first direction.

19. The semiconductor storage device according to claim 17, wherein
the plate spring includes a frame that includes an opening through which at least a part of the movable body passes and a biasing portion that protrudes from the frame, and
the plate spring is elastically deformable relative to the frame, and is in contact with the movable body and biases the movable body toward the first position.

20. The semiconductor storage device according to claim 19, wherein
the movable body has a first side and a second side, and
the biasing portion includes a pair of plate portions that are respectively disposed on the first side and the second side of the movable body in a second direction intersecting the first direction and are in contact with the movable body.
